(19) United States
(12) Patent Application Publication
(10) Pub. No.: US 2017/0227129 A1
(43) Pub. Date: Aug. 10, 2017

(54) INSTALLATION FOR PRODUCING NITRIC ACID WITH A SEALING DEVICE FOR SEALING A ROTATABLE SHAFT OF A NO COMPRESSOR AND/OR OF A RESIDUAL GAS EXPANDER

(71) Applicants: ThyssenKrupp Industrial Solutions AG, Essen (DE); ThyssenKrupp AG, Essen (DE)

(72) Inventor: Daniel Birke, Melle (DE)

(73) Assignees: ThyssenKrupp Industrial Solutions AG, Essen (DE); ThyssenKrupp AG, Essen (DE)

(21) Appl. No.: 15/329,019

(22) PCT Filed: Jul. 8, 2015
(86) PCT No.: PCT/EP2015/065556

§ 371 Date: Jan. 25, 2017

(30) Foreign Application Priority Data
Jul. 25, 2014 (DE) 10 2014 214 685.2

(51) Int. Cl. F16J 15/44; C01B 21/38; F04F 5/20; F01D 11/00; F01D 11/04; F16J 15/447; B01J 3/03

(52) U.S. Cl. CPC F16J 15/443; F16J 15/447; C01B 21/38; B01J 3/03; F01D 11/003; F01D 11/04; F04F 5/20

(57) ABSTRACT

A sealing device for sealing a rotatable shaft of a gas compressor and/or a gas expander may include first and second sealing chambers and an extraction unit. The first sealing chamber may surround the rotatable shaft and include an inlet for the supply of a sealing medium. The second sealing chamber may be separated from the first sealing chamber by a seal and may surround the rotatable shaft. The second sealing chamber may include an outlet for the discharge of the sealing medium. The extraction device may extract the sealing medium out of the second sealing chamber. The present disclosure also concerns a corresponding method. Still further, the present disclosure concerns an installation for producing nitric acid with a NO compressor and a residual gas expander as well as a corresponding method. The NO compressor and/or the residual gas expander may have such a sealing device.

### PRIOR ART

The present invention relates to a sealing device as well as a corresponding method for sealing a rotatable shaft of a gas compressor and/or a gas expander, having a first sealing chamber, which surrounds the shaft and comprises an inlet for the supply of a sealing medium, and a second sealing chamber, which is separated from the first sealing chamber by a seal and surrounds the shaft and comprises an outlet for the discharge of the sealing medium. The invention furthermore relates to an installation for producing nitric acid with a NO compressor and a residual gas expander as well as a corresponding method for operating such an installation.

Such a sealing device can be used, for example, in an installation for producing nitric acid. Such a system is known e.g. from DE 10 2008 027 232 B3. In the case of the method described there for producing nitric acid, gas which contains NO is compressed by a NO compressor. The compressed gas is conducted into a high-pressure part of the installation in which oxidation from NO to NO₂ as well as absorption of nitric acid take place. The unabsorbed residual gas is conducted to a residual gas expander in order to reduce it to ambient pressure in order to obtain energy. The energy contained in the expander can be used to operate the compressor.

The compressor and the expander of this system have in each case a rotatable shaft on which a rotating impeller is arranged. The impellers of compressor and expander are located in the inner space which is sealed off from the shaft in order to prevent the discharge of the gases conducted in compressor or expander. Sealing devices are used for sealing, which sealing devices comprise at least two sealing chambers. The sealing chambers are arranged in such a manner that they surround the shaft and are spaced apart from the inner space in the axial direction. The sealing chambers are sealed off from the inner space and from the surroundings via sealing means arranged between housing inner wall and shaft. A sealing gas is introduced into a first of the two sealing chambers, which sealing gas can partially penetrate into the inner space and partially penetrate into the adjacent second sealing chamber as a result of porous areas of the sealing means. As a result of the sealing gas acting on the sealing means, gases can be prevented from escaping from the inner space of NO compressor and/or residual gas expander into the ambient air.

The known sealing device is tried-and-tested in practice. It has nevertheless been shown that a release of nitrogen oxides can arise in the case of a failure of the sealing medium at the sealing means of NO compressor and/or residual gas expander. The nitrogen oxides can lead to irritation and damage of the respiratory passages of people who are in the vicinity of the installation.

### DISCLOSURE OF THE INVENTION

Against this background, the object of the present invention is to improve the safety of a compressor operated with a gas which is hazardous to health and/or of an expander.

The present invention achieves the object by a sealing device for sealing a rotatable shaft of a gas compressor and/or a gas expander, having a first sealing chamber, which surrounds the shaft and comprises an inlet for the supply of a sealing medium, and a second sealing chamber, which is separated from the first sealing chamber by a seal and surrounds the shaft and comprises an outlet for the discharge of the sealing medium, wherein an extraction device for the extraction of the sealing medium out of the second sealing chamber is provided.

In the case of an installation for producing nitric acid with a NO compressor and a residual gas expander, it contributes to the solution of the object if the NO compressor and/or residual gas expander has such a sealing device.

A vacuum can be generated in the second sealing chamber by the extraction device so that gas is extracted out of the second sealing chamber. Even in the case of failure of the sealing medium, gas collecting in the second sealing chamber is extracted and cannot escape into the surroundings. As a result of this, the release of hazardous gases can be prevented and thus the safety of the compressor or expander can be increased.

According to one advantageous configuration of the invention, the extraction device is formed as a jet pump. In the case of a jet pump, the extraction action is generated by a jet stream which sucks the sealing medium. Since jet pumps generally do not have any movable elements, they are low-maintenance and less prone to faults. It is particularly advantageous if a jet pump formed as an ejector is used so that a vacuum can be generated in the sealing chamber.

It is preferred if the sealing device comprises a third sealing chamber, which surrounds the shaft and comprises an outlet for the discharge of the sealing medium, wherein the second sealing chamber is arranged between the first sealing chamber and the third sealing chamber. Gas can collect in the third sealing chamber which gas arrives through porous areas of a seal between the second sealing chamber and the third sealing chamber. Such gas which escapes in an undesirable manner out of the second sealing chamber can thus be collected and this gas can be prevented from entering into the surroundings. The safety of the sealing device can thus be further improved by the third sealing chamber.

In this context, it has been shown to be particularly advantageous if the sealing medium can be extracted out of the third sealing chamber via the extraction device. A vacuum can be generated not only in the second sealing chamber, but also in the third sealing chamber by a joint extraction device for extraction of the sealing medium out of the second sealing chamber and the third sealing chamber. Gases can be extracted out of the second sealing chamber and the third sealing chamber. As a result of this, the safety of the compressor or expander can be further improved. Alternatively, two separate extraction devices can be used to extract the sealing medium out of the second sealing chamber and out of the third sealing chamber. This brings with it the advantage of a certain degree of redundancy. This is because, in the event of failure of one of the two extraction devices, the sealing medium can be extracted by the respective other extraction device such that a complete failure of the extraction function does not occur.

It is furthermore advantageous if the first sealing chamber is formed to be outlet-free. Due to the fact that the first sealing chamber does not have an outlet for the sealing medium, the sealing medium can only escape through porous areas in the seals which seal off the first sealing chamber from the shaft. The majority of the sealing medium preferably flows through a seal between the first sealing chamber and the inner space of the expander or compressor, while the smaller part escapes through a seal between the first sealing chamber and the second sealing chamber. Alternatively, the first sealing chamber can comprise an outlet. The outlet of the first locking chamber can optionally be connected to a joint extraction device or a separate extraction device so that the sealing medium can also be extracted out of the first sealing chamber.

One advantageous configuration provides that the second sealing chamber is formed to be inlet-free so that gases can reach the second sealing chamber exclusively through porous areas in the respective seals between the first sealing chamber and the second sealing chamber or seals between any third sealing chamber and the second sealing chamber. It is alternatively or additionally possible to form the third sealing chamber to be inlet-free so that gases can reach the third sealing chamber exclusively through porous areas in the respective seals between the second sealing chamber and the third sealing chamber or seals between the surroundings and the third sealing chamber. According to a further modification, it can be provided that the second sealing chamber and/or the third sealing chamber comprise/comprises an inlet via which a sealing medium can be supplied which is preferably identical to the sealing medium which is supplied to the first sealing chamber.

In the case of an installation of the above-mentioned type, it is advantageous if a joint extraction device is provided for the NO compressor and the residual gas expander. The outlay for sealing NO compressor and residual gas expander can be reduced by a joint extraction device for the NO compressor and the residual gas expander.

The above-mentioned object is furthermore achieved by a method for sealing a rotatable shaft of a gas compressor and/or a gas expander, wherein a sealing device is used, having a first sealing chamber, which surrounds the shaft and comprises an inlet for the supply of a sealing medium, and a second sealing chamber, which is separated from the first sealing chamber by a seal and surrounds the shaft and comprises an outlet for the discharge of the sealing medium, wherein a sealing medium is introduced into the first sealing chamber and the sealing medium is extracted out of the second sealing chamber.

In the case of a method for operating an installation for producing nitric acid with a NO compressor and a residual gas expander, the above-mentioned object is achieved in that the sealing method described above is used to seal the shafts of NO compressor and/or residual gas expander.

The same advantages as have already been described in conjunction with the sealing device are achieved in both methods.

One advantageous configuration of the method provides that the sealing medium is extracted out of a third sealing chamber, which surrounds the shaft and comprises an outlet for the discharge of the sealing medium, wherein the second sealing chamber is arranged between the first sealing chamber and the third sealing chamber.

In the case of the method, a sealing gas, in particular sealing air, is preferably used as the sealing medium. Primary air, secondary air, instrument air or installation air can be used as the sealing air. Alternatively, an inert gas can be used as the sealing gas.

Part of the residual gas supplied to the residual gas expander is particularly preferably used as the sealing medium. This brings with it the advantage that the residual gas is in any event present in the production process for the production of nitric acid and no further medium has to be provided.

It is advantageous if the sealing medium is extracted via a jet pump which is operated with a jet stream from the sealing medium. If the sealing medium is used as the propellant gas for the jet pump, it is not necessary to provide a further medium for operation of the jet pump.

In the case of the methods according to the invention, the advantageous configurations described in conjunction with the sealing device or the installation for producing nitric acid can alternatively or additionally also be used.

Further details, features and advantages of the invention will become apparent from the drawings and from the following description of preferred embodiments on the basis of the drawings. The drawings merely illustrate exemplary embodiments of the invention which do not restrict the concept of the invention.

### BRIEF DESCRIPTION OF THE FIGURES

FIG. 1 shows a schematic representation of a first exemplary embodiment of the installation according to the invention for nitric acid production,

FIG. 2 shows a schematic representation of a second exemplary embodiment of the installation according to the invention for nitric acid production,

FIG. 3 shows a schematic sectional representation of a sealing device according to the invention.

### EMBODIMENTS OF THE INVENTION

Identical parts are always provided with the same reference numbers in the various figures and are therefore generally also only cited or mentioned once in each case.

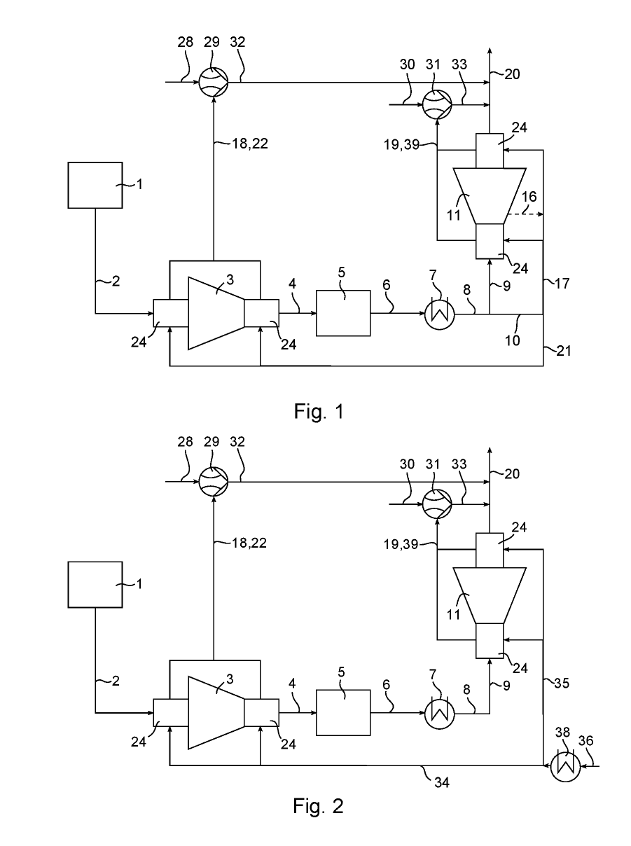

FIG. 1 schematically represents an installation for the production of nitric acid (HNO3). The installation has a low-pressure part 1 in which an ammonia/air mixture is oxidized by means of a catalytic converter to form nitrogen monoxide (NO) and water. Gaseous nitrogen monoxide 2 is conducted into a NO compressor 3 in which the nitrogen monoxide is compressed. Compressed nitrogen monoxide 4 exiting from NO compressor 3 is moved into a high-pressure part 5 of the installation in which oxidation of NO to form nitrogen dioxide (NO₂) and absorption of nitric acid (HNO₃) take place. Unabsorbed residual gas 6 is conducted via a heat exchanger 7 to a residual gas expander 11 in order to reduce it to ambient pressure in order to obtain energy and discharge it into an exhaust gas flow 20.

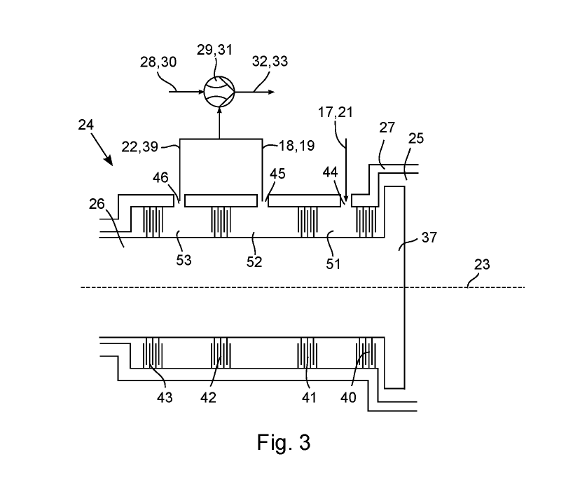

Since the escape of gases containing nitrogen can lead to irritation or damage of the respiratory passages, particular precautions are taken in the case of NO compressor 3 and residual gas expander 11 of the installation in order to prevent the undesirable escape of the gases introduced into NO compressor 3 and residual gas expander 11. Both NO compressor 3 and residual gas expander 11 comprise two sealing devices 24 via which rotatable shafts 26 of NO compressor 3 or residual gas expander 11 are sealed and which shall be explained in greater detail below on the basis of the representation in FIG. 3.

FIG. 3 shows a cross section through a shaft 26 of NO compressor 3 or residual gas expander 11, which shaft 26 is mounted about a rotational axis 23 rotatably with respect to a fixed housing 27. An impeller 37, which, in the case of NO compressor 3, contributes to the compression of the conveyed gas or, in the case of residual gas expander 11, is driven by the introduced gas, is arranged on shaft 26 in inner space 25 of NO compressor 3 or of residual gas expander 11. A multi-stage sealing device 24 is provided to seal off the inner space from the surroundings. Sealing device 24 comprises a first sealing chamber 51 which entirely surrounds shaft 26. First sealing chamber 51 is formed to be annular. It is separated from inner space 25 by a seal 40.

Seal 40 is formed as a labyrinth seal which has a certain degree of porosity as a result of its design. First sealing chamber 51 comprises an inlet 44 through which a sealing medium formed as a sealing gas can be introduced into first sealing chamber 51.

Sealing device 24 furthermore comprises a second sealing chamber 52 which has an annular design and surrounds shaft 26. Second sealing chamber 52 is arranged directly adjacent to first sealing chamber 51. It is separated from first sealing chamber 52 by a seal 41. Seal 41 is also formed as a labyrinth seal. There is provided in second sealing chamber 52 an outlet 45 via which gas can escape out of second sealing chamber 52. First sealing chamber 51 is arranged between inner space 25 of NO compressor 3 or residual gas expander 11 and second sealing chamber 52.

A third sealing chamber 53 is also provided which is likewise configured to be annular and surrounds shaft 26. Third sealing chamber 53 is arranged directly adjacent to second sealing chamber 52 and separated from the second sealing chamber by a seal 42. On its side opposite second sealing chamber 52, a further seal 43 is provided via which third sealing chamber 53 is sealed off from the surroundings. Both seals 42, 43 which delimit third sealing chamber 53 are configured as labyrinth seals.

First sealing chamber 51 is formed to be outlet-free so that the sealing gas introduced via inlet 44 can leave the first sealing chamber exclusively through both seals 40 and 41 which delimit first sealing chamber 51 from inner space 25 and second sealing chamber 52. Second sealing chamber 52 and third sealing chamber 53 are formed to be inlet-free. That is to say that gases can arrive at second sealing chamber 52 solely via seals 41 and 42, which seals 41 and 42 delimit second sealing chamber 52 from first sealing chamber 51 and third sealing chamber 53. Gases can arrive at third sealing chamber 53 exclusively through both seals 42 and 43 which delimit third sealing chamber 53 from second sealing chamber 52 and the surroundings.

In order to improve the safety of sealing device 24, outlet 45 of second sealing chamber 52 is connected to extraction device 29, 31. A vacuum can be generated by extraction device 29,31 in second sealing chamber 52 so that gas is extracted out of second sealing chamber 52. Even in the case of failure of the sealing medium, gas collecting in second sealing chamber 52 is extracted and cannot escape into the surroundings. As a result of this, the release of hazardous gases can be prevented and thus the safety of NO compressor 3 or expander 11 can be improved. Gas 32, 33 extracted by extraction device 29, 31 is supplied to exhaust gas flow 20 of residual gas expander 11.

As is apparent from the representation in FIG. 3, outlet 46 of third sealing chamber 53 is also connected to extraction device 29, 31 so that gas can also be extracted out of third sealing chamber 53. In this regard, second sealing chamber 52 and third sealing chamber 53 are connected to a joint extraction device 29, 31.

Extraction device 29, 31 is formed as a jet pump, in particular as an ejector. Extraction device 29, 31 is operated with a jet stream 28, 30. A flow from the sealing medium can be used as the jet stream.

In the case of the installation represented in FIG. 1 for nitric acid production, two separate extraction devices 29, 31 are provided, wherein a first extraction device 29 is connected to NO compressor 3 and a second extraction device 31 is connected to residual gas expander 11. Extraction flow 18, which is extracted out of second sealing chamber 52 of NO compressor 3, is supplied together with extraction flow 22, which is extracted out of the third sealing chamber of the NO compressor, to first extraction device 29. Exhaust gas flow 19, which is extracted out of second sealing chamber 52 of residual gas expander 11, is supplied together with extraction flow 39, which is extracted out of third sealing chamber 53 of residual gas expander 11, to second extraction device 31.

In contrast to the first exemplary embodiment, second sealing chambers 52 and third sealing chambers 53 of NO compressor 3 and residual gas expander 11 can be connected to a joint extraction device.

In the case of the installation according to the first exemplary embodiment, a sub-flow 17, 21 of residual gas 8 supplied to residual gas expander 11 is used as the sealing medium. For this purpose, residual gas flow 8 coming from heat exchanger 7 is divided into two sub-flows 9, 10, wherein a first sub-flow 9 is supplied to residual gas expander 11. A second sub-flow 10 is divided into two sub-flows 17, 21, wherein a first sub-flow 17 is supplied to residual gas expander 11 and a second sub-flow 21 is supplied to compressor 3. Alternatively or additionally, the residual gas can be removed from an intermediate stage of residual gas expander 11. The residual gas removed from the intermediate stage is represented by the reference number 16 in the representation in FIG. 1.

The installation represented in FIG. 2 for nitric acid production is formed to be substantially identical to the installation according to the first exemplary embodiment. In contrast to the first exemplary embodiment, a sealing gas flow 36 is supplied to the installation from the outside. Sealing gas flow 36 is guided through a heat exchanger 38 and then divided into two sub-flows 34 and 35, wherein a first sub-flow 34 is supplied to NO compressor 3 and a second sub-flow 35 is supplied to residual gas expander 11. Sealing gas flow 36 can be formed from primary air, secondary air, instrument air or installation air. Alternatively, an inert gas can be used as the sealing gas.

The installations described above for nitric acid production with an NO compressor 3 and a residual gas expander 11 comprise in each case sealing devices 24 for sealing rotatable shafts 26 of NO compressor 3 and of residual gas expander 11. The sealing devices encompass a first sealing chamber 51, which surrounds shaft 26 and comprises an inlet 44 for the supply of a sealing medium, and a second sealing chamber 52, which is separated from first sealing chamber 51 by a seal 41 and surrounds shaft 26 and comprises an outlet 45 for the discharge of the sealing medium, wherein the sealing medium is discharged out of second sealing chamber 52 by an extraction device 29, 31.

### LIST OF REFERENCE NUMBERS

1 Low-pressure part
2 Nitrogen monoxide
3 NO compressor
4 Compressed nitrogen monoxide
5 High-pressure part
6 Residual gas
7 Heat exchanger
8 Residual gas
9 Residual gas sub-flow
10 Residual gas sub-flow
11 Residual gas expander
16 Residual gas flow from intermediate stage
17 Residual gas sub-flow
18, 19 Extraction flow
20 Exhaust gas flow
21 Residual gas sub-flow
22 Extraction flow
23 Rotational axis
24 Sealing device
25 Inner space
26 Shaft
27 House
28 Jet stream
29 Extraction device
30 Jet stream
31 Extraction device
34, 35 Sub-flow
36 Sealing gas flow
37 Impeller
38 Heat exchanger
39 Extraction flow
40, 41, 42, 43 Seal
44 Inlet
45, 46 Outlet
51 First sealing chamber
52 Second sealing chamber
53 Third sealing chamber

1.-14. (canceled)

15. An installation for producing nitric acid with a NO compressor and a residual gas expander, wherein at least one of the NO compressor or the residual gas expander includes a sealing device for sealing a rotatable shaft of the NO compressor or the residual gas expander, the sealing device comprising:
a first sealing chamber that surrounds the rotatable shaft and includes an inlet for supply of a sealing medium;
a second sealing chamber that is separated from the first sealing chamber by a seal and surrounds the rotatable shaft, the second sealing chamber including an outlet for discharge of the sealing medium; and
an extraction device for extraction of the sealing medium out of the second sealing chamber.

16. The installation of claim 15 wherein the extraction device comprises a jet pump.

17. The installation of claim 15 wherein the extraction device comprises an ejector.

18. The installation of claim 15 further comprising a third sealing chamber that surrounds the rotatable shaft and includes an outlet for discharge of the sealing medium, wherein the second sealing chamber is disposed between the first and third sealing chambers.

19. The installation of claim 18 wherein the extraction device is configured to extract the sealing medium out of the third sealing chamber.

20. The installation of claim 18 wherein the second and third sealing chambers are inlet-free.

21. The installation of claim 15 wherein the first sealing chamber is outlet-free.

22. The installation of claim 15 wherein the second sealing chamber is inlet-free.

23. The installation of claim 15 further comprising a joint extraction device for the NO compressor and the residual gas expander.

24. The installation of claim 15 wherein the extraction device is a joint extraction device for the NO compressor and the residual gas expander.

25. A method for operating an installation for producing nitric acid with a NO compressor and a residual gas expander and for sealing a shaft of at least one of the NO compressor or the residual gas expander, wherein the installation includes a sealing device that comprises a first sealing chamber surrounding the shaft and including an inlet for supply of a sealing medium and a second sealing chamber that is separated from the first sealing chamber by a seal, that surrounds the shaft, and that includes an outlet for discharge of the sealing medium, the method comprising:
introducing the sealing medium into the first sealing chamber; and
extracting the sealing medium out of the second sealing chamber.

26. The method of claim 25 further comprising extracting the sealing medium out of a third sealing chamber that surrounds the shaft and includes an outlet for discharge of the sealing medium, wherein the second sealing chamber is disposed between the first and third sealing chambers.

27. The method of claim 25 wherein the sealing medium is a sealing gas.

28. The method of claim 25 wherein the sealing medium is sealing air.

29. The method of claim 25 wherein the sealing medium is a working gas.

30. The method of claim 25 further comprising extracting the sealing medium with a jet pump that is operated with a jet stream form the sealing medium.

31. The method of claim 25 using part of a residual gas supplied to the residual gas expander as the sealing medium.
